(19) United States
(12) Patent Application Publication
(10) Pub. No.: US 2025/0189328 A1
(43) Pub. Date: Jun. 12, 2025

(54) ROUTE SEARCH METHOD USING A USER PREFERRED ROUTE AND A DEVICE FOR IMPLEMENTING THE METHOD

(71) Applicant: HYUNDAI AUTOEVER CORP., Seoul (KR)

(72) Inventors: Hyeon Seung Ji, Seoul (KR); Wan Kyu Yun, Seoul (KR)

(73) Assignee: HYUNDAI AUTOEVER CORP., Seoul (KR)

(21) Appl. No.: 18/937,624

(22) Filed: Nov. 5, 2024

(30) Foreign Application Priority Data
Dec. 11, 2023 (KR) 10-2023-0178577

(51) Int. Cl. G01C 21/34

(52) U.S. Cl. CPC G01C 21/3484; G01C 21/3492

(57) ABSTRACT

A route search method includes determining a user preferred route for a destination proximity area based on information about a plurality of actual driving routes used by a user to reach a destination and a number of times that each actual driving route, among the plurality of actual driving routes used by the user has been used. The route search method also includes providing a recommended route comprising the user preferred route in response to an input of the destination. The destination proximity area is an area within a preset radius from the destination.

### CROSS-REFERENCE TO RELATED APPLICATION

This application claims the benefit of and priority to Korean Patent Application No. 10-2023-0178577, filed on Dec. 11, 2023, the entire contents of which are hereby incorporated herein.

### FIELD OF TECHNOLOGY

The present disclosure relates to a route search method using a user preferred route and a device for implementing the method.

### BACKGROUND

In a conventional route search using a navigation device, when a user inputs a starting point and a destination, various routes to reach the destination from the starting point using various options are provided.

These various options include, for example, a real-time fast route, a shortest-distance route, a toll-free route, and a route using a specific road. The user selects a desired option from these options and uses a route to reach the destination.

However, if the destination is a place (e.g., home or office) that the user frequently visits, most users tend to drive along a route that they prefer and are familiar with within an area close to the destination, regardless of the various options for route search.

Therefore, when the user sets a frequently visited familiar place as a destination, if the navigation device fails to guide a route that the user frequently uses within an area close to the destination, its route search results may be distrusted.

The discussions in this section are intended merely to provide background information and do not constitute an admission of prior art.

### SUMMARY

Aspects of the present disclosure provide a route search method using a user preferred route, the method being employed in a search for a route to reach a destination to recommend a customized route for a user in a destination proximity area based on routes that the user has actually traveled, and a device for implementing the method.

Aspects of the present disclosure also provide a route search method using a user preferred route, the method being employed in a search for a route to reach a destination to provide search results so that routes found based on time, distance, etc. within a destination proximity area and a route preferred by a user can be compared, and a device for implementing the method.

Aspects of the present disclosure also provide a route search method using a user preferred route, the method being employed in a search for a route to reach a destination to recommend a customized route for a user according to time based on routes that the user has actually traveled within a destination proximity area, and a device for implementing the method.

Aspects of the present disclosure also provide a route search method using a user preferred route, the method being employed to provide a customized route to a user in a search for a route to a new destination that the user has never actually driven to by using actual driving routes of drivers with similar driving tendencies to the user around the destination, and a device for implementing the method.

However, aspects of the present disclosure are not restricted to the one set forth herein. The above and other aspects of the present disclosure should become more apparent to one of ordinary skill in the art to which the present disclosure pertains by referencing the detailed description of the present disclosure given below.

According to an aspect of the present disclosure, a route search method is provided. The route search method may be performed by a computing device. The route search method includes determining a user preferred route for a destination proximity area based on information about a plurality of actual driving routes used by a user to reach a destination and the number of times that each actual driving route has been used. The route search method also includes providing a recommended route comprising the user preferred route in response to the input of the destination. The destination proximity area is an area within a preset radius from the destination.

In some embodiments, determining the user preferred route may include obtaining data about a plurality of actual driving routes of the user collected during a preset period of time before the input of the destination and data about the number of times that each actual driving route has been used.

In some embodiments, determining the user preferred route may include generating, as the user preferred route, an actual driving route that has been used a preset reference number of times or more among the actual driving routes of the user.

In some embodiments, determining the user preferred route may include obtaining information about the number of search requests made by the user for each of the actual driving routes, and generating, as the user preferred route, an actual driving route for which a preset reference number of search requests or more have been made among the actual driving routes of the user.

In some embodiments, determining the user preferred route may include obtaining information about a driving ratio and required time of each of a plurality of roads traveled to reach the destination, and generating, as the user preferred route, an actual driving route that requires a minimum time to reach the destination among the actual driving routes of the user by using the driving ratio and required time of each of the roads.

In some embodiments, determining the user preferred route may include dividing data about the actual driving routes of the user into weekday/weekend data and peak/off-peak data according to driving time, and generating the user preferred route for each time by using the data divided according to the driving time.

In some embodiments, providing the recommended route comprising the user preferred route in response to the input of the destination may include providing the recommended route at a starting point, and providing a route with a faster expected arrival time among the recommended route and a plurality of route search results for the destination in response to entering within a preset distance from the destination.

According to another aspect of the present disclosure, a route search method is provided. The route search method may be performed by a computing device. The route search method includes determining a preferred route of a first user for a destination proximity area based on information about actual driving routes used by a first driver cluster to reach a destination and the number of times that each actual driving route has been used. The route search method also includes providing a recommended route comprising the preferred route of the first user in response to the input of the destination. The destination proximity area is an area within a preset radius from the destination, and the first user is a user corresponding to the first driver cluster.

In some embodiments, determining the preferred route of the first user for the destination proximity area may include generating a plurality of driver clusters with different driving tendencies by performing clustering using data about actual driving routes used by a plurality of drivers to reach the destination.

In some embodiments, determining the preferred route of the first user for the destination proximity area may include, when the destination is not included in a plurality of actual driving routes of the first user, determining the first driver cluster with a similar driving tendency to the first user among the driver clusters based on an analysis of the actual driving routes of the first user, and generating the preferred route of the first user for the destination proximity area based on actual driving routes of drivers which have been used a preset reference number of times or more among a plurality of actual driving routes used by drivers belonging to the first driver cluster to reach the destination.

In some embodiments, generating the driver clusters with the different driving tendencies may include analyzing turning preference and risk tolerance of each driver while driving based on the data about the actual driving routes of the drivers, and classifying drivers with similar analysis results into the same driver cluster.

According to another aspect of the present disclosure, a computing device is provided. The computing device includes one or more processors, a communication interface configured to communicate with an external device, and a memory configured to store a computer program to be executed by the one or more processors. The computer program comprises instructions for performing an operation of determining a user preferred route for a destination proximity area based on information about a plurality of actual driving routes used by a user to reach a destination and the number of times that each actual driving route has been used, and an operation of providing a recommended route comprising the user preferred route in response to the input of the destination, wherein the destination proximity area is an area within a preset radius from the destination.

In some embodiments, the operation of determining the user preferred route may include an operation of obtaining data about a plurality of actual driving routes of the user collected during a preset period of time before the input of the destination and data about the number of times that each actual driving route has been used.

In some embodiments, the operation of determining the user preferred route may include an operation of generating, as the user preferred route, an actual driving route that has been used a preset reference number of times or more among the actual driving routes of the user.

In some embodiments, the operation of determining the user preferred route may include an operation of obtaining information about the number of search requests made by the user for each of the actual driving routes, and an operation of generating, as the user preferred route, an actual driving route for which a preset reference number of search requests or more have been made among the actual driving routes of the user.

In some embodiments, the operation of determining the user preferred route may include an operation of obtaining information about a driving ratio and required time of each of a plurality of roads traveled to reach the destination, and an operation of generating, as the user preferred route, an actual driving route that requires a minimum time to reach the destination among the actual driving routes of the user by using the driving ratio and required time of each of the roads.

In some embodiments, the operation of determining the user preferred route may include an operation of dividing data about the actual driving routes of the user into weekday/weekend data and peak/off-peak data according to driving time, and an operation of generating the user preferred route for each time by using the data divided according to the driving time.

In some embodiments, the operation of providing the recommended route comprising the user preferred route in response to the input of the destination may include an operation of preferentially providing the recommended route at a starting point, and an operation of providing a route with a faster expected arrival time among the recommended route and a plurality of route search results for the destination in response to entering within a preset distance from the destination.

In some embodiments, the operation of determining the user preferred route may include an operation of determining the user preferred route of the user for the destination proximity area based on information about actual driving routes used by a first driver cluster to reach the destination and the number of times that each actual driving route has been used, wherein the user is a user corresponding to the first driver cluster.

In some embodiments, the operation of determining the user preferred route of the user may include an operation of generating a plurality of driver clusters with different driving tendencies by performing clustering using data about actual driving routes used by a plurality of drivers to reach the destination, an operation of, when the destination is not included in the actual driving routes of the user, determining the first driver cluster with a similar driving tendency to the user among the driver clusters based on an analysis of the actual driving routes of the user; and an operation of generating the user preferred route of the user for the destination proximity area based on actual driving routes of drivers which have been used a preset reference number of times or more among a plurality of actual driving routes used by drivers belonging to the first driver cluster to reach the destination.

### BRIEF DESCRIPTION OF THE DRAWINGS

These and/or other aspects should become more apparent and more readily appreciated from the following description taken in conjunction with the accompanying drawings, in which:

FIG. 1 illustrates the configuration of a route search system using a user preferred route according to an embodiment of the present disclosure;

FIG. 2 is a flowchart illustrating a route search method using a user preferred route according to an embodiment of the present disclosure;

FIG. 3 is a flowchart illustrating a detailed process of some operations illustrated in FIG. 2 according to an embodiment of the present disclosure;

FIG. 4 is a flowchart illustrating a route search method using a user preferred route according to an embodiment of the present disclosure;

FIGS. 5 and 6 are flowcharts illustrating detailed processes of some operations illustrated in FIG. 4 according to an embodiment of the present disclosure;

FIG. 7 is an example of providing a user preferred route for a destination proximity area according to embodiments of the present disclosure;

FIG. 8 is an example of providing a recommended route in consideration of the number of times that actual driving routes of a user have been used according to embodiments of the present disclosure;

FIG. 9 is an example of providing a user preferred route for a destination proximity area in consideration of time according to embodiments of the present disclosure;

FIG. 10 is an example of generating a user's preferred route by using actual driving routes of a driver cluster with a similar driving tendency to the user when finding a route to a new destination according to embodiments of the present disclosure; and

FIG. 11 is a hardware configuration diagram of an exemplary computing device that can implement methods according to an embodiment of the present disclosure.

### DETAILED DESCRIPTION

Hereinafter, embodiments of the present disclosure are described in detail with reference to the accompanying drawings. The advantages and features of the present disclosure and methods of accomplishing the same should be understood more readily by reference to the following detailed description of embodiments and the accompanying drawings. The present disclosure may, however, be embodied in many different forms and should not be construed as being limited to the embodiments set forth herein. Rather, these embodiments are provided to make this disclosure thorough and complete and to fully convey the concepts of the disclosure to those having ordinary skill in the art to which the present disclosure pertains. The scope of the present disclosure should only be construed on the basis of the accompanying claims in such a manner that all of the technical ideas included within the scope equivalent to the claims are included in the scope of the present disclosure.

In adding reference numerals to the components of the accompanying drawings, it should be noted that the same reference numerals are assigned to the same components as much as possible even though the components are shown in different drawings. In addition, in describing the present disclosure, when it was determined that a detailed description of a related well-known configuration or function may obscure the gist of the present disclosure, the detailed description thereof has been omitted.

Unless otherwise defined, all terms used in the present specification (including technical and scientific terms) are used in a sense that can be commonly understood by those having ordinary skill in the art. In addition, the terms defined in commonly used dictionaries should not be ideally or excessively interpreted unless the terms are specifically defined herein. The terminology used herein is only for the purpose of describing particular embodiments and is not intended to be limiting of the present disclosure. In this specification, the singular also includes the plural unless specifically stated otherwise in the present disclosure.

In addition, in describing components of this disclosure, terms, such as first, second, A, B, (a), (b), may be used. These terms are only for distinguishing the components from other components, and the nature or order of the components is not limited by the terms. When a component is described as being “connected,” “coupled” or “contacted” to another component, that component may be directly connected to or contacted with the other component. However, it should be understood that another component also may be “connected,” “coupled” or “contacted” between the component and the other component.

The terms “comprise”, “include”, “have”, etc. when used in this specification, specify the presence of stated features, integers, steps, operations, elements, components, and/or combinations thereof, but do not preclude the presence or addition of one or more other features, integers, steps, operations, elements, components, and/or combinations thereof.

When a component, device, module, element, or the like of the present disclosure is described as having a purpose or performing an operation, function, or the like, the component, device, or element should be considered herein as being “configured to” meet that purpose or perform that operation or function.

Hereinafter, embodiments of the present disclosure are described in detail with reference to the accompanying drawings.

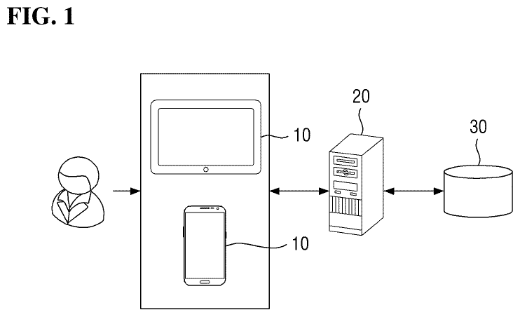

FIG. 1 illustrates a configuration of a route search system using a user preferred route according to an embodiment of the present disclosure.

Referring to FIG. 1, a system according to an embodiment of the present disclosure includes a user terminal 10 having a navigation function and a server 20. The user terminal 10 is connected to the server 20 via a network. The server 20 is connected to a database 30 that stores traffic information and user driving history information via a network and may search data stored in the database 30. The traffic information and the user driving history information stored in the database 30 may be physically stored in the same DB server or stored in different DB servers.

The user terminal 10 is a terminal on which an application capable of executing a navigation function is installed. The user terminal 10 may be, for example, a smartphone, a navigation-only device, a tablet, etc.

When a destination is input while the user terminal 10 is displaying an execution screen of the navigation function, the user terminal 10 transmits a route search request to the server 20 to reach the destination.

The server 20 generates a user preferred route for a destination proximity area at the request of the user terminal 10 by using the traffic information and the user driving history information stored in the database 30. The destination proximity area refers to an area within a preset radius from the destination. For example, the destination proximity area may be set to an area within a radius input from the user terminal 10 or may be set to an area within a radius stored as a default value in the user terminal 10 or the server 20. Here, the user driving history information may include information about actual driving routes for each destination and the number of times that each actual driving route has been used.

The server 20 may generate a shortest time route, a shortest distance route, a toll-free route, etc. to reach the destination, in addition to the user preferred route.

The server 20 may provide the user preferred route for the destination proximity area generated using the traffic information and the user driving history information to the user terminal 10, the user terminal 10 may display a recommended route including the user preferred route received from the server 20.

For example, the recommended route may be generated using only the user preferred route from a starting point to the destination. The recommended route may also be generated using a general fast route from the starting point to a location at a preset distance from the destination and then using the user preferred route until reaching the destination.

In an embodiment, if the destination input from the user terminal 10 is a new destination that a user has never driven to, the server 20 may generate the user's preferred route to reach the new destination by using driving history information of drivers who have actually driven to the new destination.

Specifically, the server 20 may perform clustering by using the driving history information of the drivers who have actually driven to the new destination. Accordingly, a plurality of driver clusters with different driving tendencies may be generated. The driving tendencies refer to the habitual patterns and behaviors that a driver exhibits while operating a vehicle. For example, driving tendencies of drivers may include driving routes that the drivers habitually use to reach a destination. The server 20 may determine a driver cluster with a similar driving tendency to the user among the driver clusters by analyzing the user's actual driving routes and may generate the user's preferred route to reach the new destination by using actual driving routes of drivers belonging to the determined driver cluster.

The user's preferred route may be generated using an actual driving route that the drivers belonging to the driver cluster with the similar driving tendency to the user have traveled a preset reference number of times or more to reach the destination.

According to the configuration of the system described above, in a search for a route to a destination, a user's preferred route in a destination proximity area is recommended based on routes that the user has actually traveled. Therefore, the user's satisfaction with the route search result of a navigation can be increased. In addition, in a search for a route to a new destination that the user has never actually driven to, a preferred route may be provided to the user by using actual driving routes of drivers with similar driving tendencies to the user around the destination.

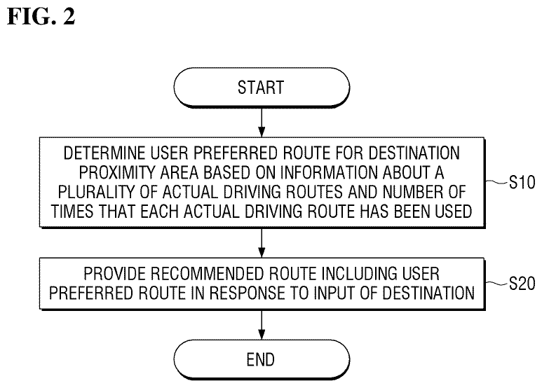

FIG. 2 is a flowchart illustrating a route search method using a user preferred route according to an embodiment of the present disclosure.

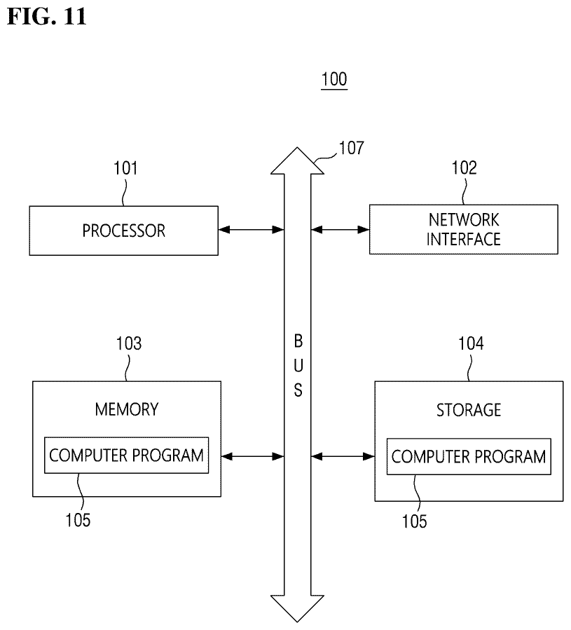

The route search method using the user preferred route according to the embodiment of the present disclosure may be executed by the user terminal 10 or the server 20 illustrated in FIG. 1. The user terminal 10 or the server 20 executing the method may be a computing device 100 illustrated in FIG. 11. The user terminal 10 may be, for example, a smartphone, a navigation-only device, a tablet, etc. The server 20 may be a server device that provides a navigation service for route search.

It should be noted that a subject performing some operations included in the route search method may be omitted, and in such a case, the subject is the computing device 100.

According to the embodiment of the present disclosure described below, in a search for a route to reach a destination, a user's preferred route in a destination proximity area may be recommended based on routes that the user has actually traveled.

In an operation S10, the computing device 100 determines a user preferred route for a destination proximity area based on information about a plurality of actual driving routes used by a user to reach a destination and the number of times that each actual driving route has been used. The destination proximity area refers to an area within a preset radius from the destination. For example, the destination proximity area may be set to an area within a radius input by a user of the computing device 100 or may be set to an area within a radius stored as a default value in the computing device 100. The user preferred route may be determined to be one of the routes that the user has actually traveled to reach the destination for a predetermined period of time before the user makes a route search request for the destination.

In an embodiment, the computing device 100 may obtain data about a plurality of actual driving routes of the user collected during a preset period of time before the input of the destination and data about the number of times that each actual driving route has been used and may determine the user preferred route through analysis using the obtained data.

For example, when finding a route to a destination ‘office’ according to the user's input, the computing device 100 may generate, as the user preferred route, a route that has been used a preset reference number of times or more (e.g., five times or more) among several routes that the user actually traveled in an area within a radius of, e.g., 3 kilometers (km) from the ‘office’ to reach the destination ‘office’ during one month before the input of the destination.

In an embodiment, a higher priority is given to the user preferred route generated for the destination ‘office’ than to other routes extracted using other search options (e.g., shortest time, shortest distance, toll-free route, via specific road, etc.). Therefore, the user preferred route may be preferentially provided to the user than other routes.

As another example, when finding a route to a destination ‘sports center’ according to the user's input, the computing device 100 may generate, as the user preferred route, a route that has been used a preset reference number of times or more (e.g., seven times or more) among several routes that the user actually traveled in an area within a radius of, e.g., 2 km from the ‘sports center’ to reach the destination ‘sports center’ during two months before the input of the destination.

As described above, when the computing device 100 finds a route to reach a destination, the computing device 100 may generate, as a user preferred route, an actual driving route that has been used a preset reference number of times or more among a user's actual driving routes collected during a preset period of time within a destination proximity area corresponding to an area within a preset radius from the destination. The destination proximity area may be set to, for example, an area within a radius input by the user or an area within a radius stored as a default value in the computing device 100.

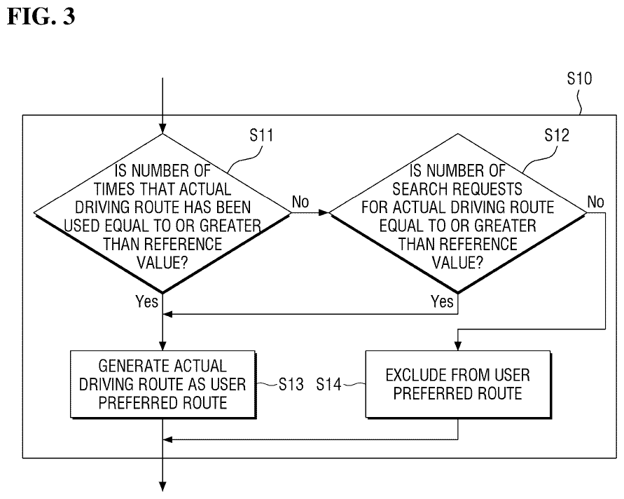

In an embodiment, referring to FIG. 3, the operation S10 may include detailed operations S11-S14.

In an operation S11, the computing device 100 determines whether the number of times that the user has used each actual driving route to reach the destination is equal to or greater than a preset reference value. In response to determining in the operation S11 that the number of times the user has used an actual driving route is equal to or greater than the reference value, the computing device 100 generates the actual driving route as the user preferred route in an operation S13.

On the other hand, in response to determining in the operation S11 that the number of times the user has used the actual driving route is less than the reference value, the computing device 100 further determines in an operation S12 whether the number of search requests made by the user for the actual driving route is equal to or greater than a preset reference value.

In response to determining in the operation S12 that the number of search requests is equal to or greater than the reference value, the computing device 100 generates the actual driving route as the user preferred route in operation S13. On the other hand, in response to determining in the operation S12 that the number of search requests is less than the reference value, the computing device 100 excludes the actual driving route from the user preferred route in an operation S14.

As described above, the computing device 100 may determine whether each route is a route preferred by a user in consideration of not only the number of times that the user has actually used each actual driving route to reach a destination, but also the number of search requests if there are cases where the user only made a search request for a route without actually using the route.

In an embodiment, to determine the user preferred route, information about a driving ratio and required time of each of a plurality of roads traveled to reach the destination may be obtained based on actual driving routes used by the user, and an actual driving route that requires a minimum time to reach the destination among the actual driving routes of the user may be generated as the user preferred route by using the information.

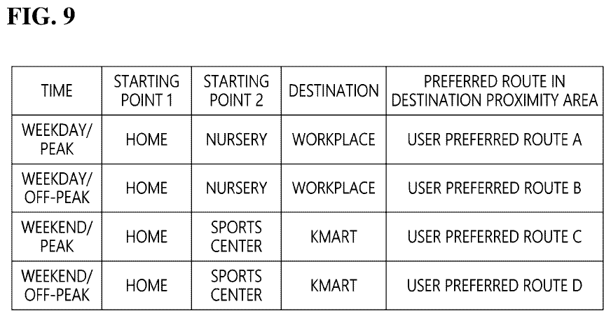

In an embodiment, referring to FIG. 9, when determining the user preferred route, the computing device 100 may determine a different user preferred route according to time.

For example, the computing device 100 may divide data about the actual driving routes of the user into weekday/weekend data and peak/off-peak data according to driving time and may generate a user preferred route for each time using the data divided by time.

Referring to a table in FIG. 9, in the case of a ‘weekday/peak’ time, a preferred route in a destination proximity area to reach a destination ‘workplace’ may be determined to be ‘user preferred route A’. In the case of a ‘weekday/off-peak’ time, the preferred route in the destination proximity area to reach the destination ‘workplace’ may be determined to be ‘user preferred route B’.

In addition, in the case of a ‘weekend/peak’ time, the preferred route in the destination proximity area to reach a destination ‘Kmart’ may be determined to be ‘user preferred route C’. In the case of a ‘weekend/off-peak’ time, the preferred route in the destination proximity area to reach the destination ‘Kmart’ may be determined to be ‘user preferred route D’.

As described above, because actual driving routes used by a user may vary according to whether it is a weekday/weekend and whether it is a ‘peak/off-peak’ time, a user preferred route suitable for each time may be generated. Accordingly, a more satisfactory route can be provided to the user.

Referring again to FIG. 2, in an operation S20, the computing device 100 provides a recommended route including the user preferred route determined in the operation S10 in response to the input of the destination.

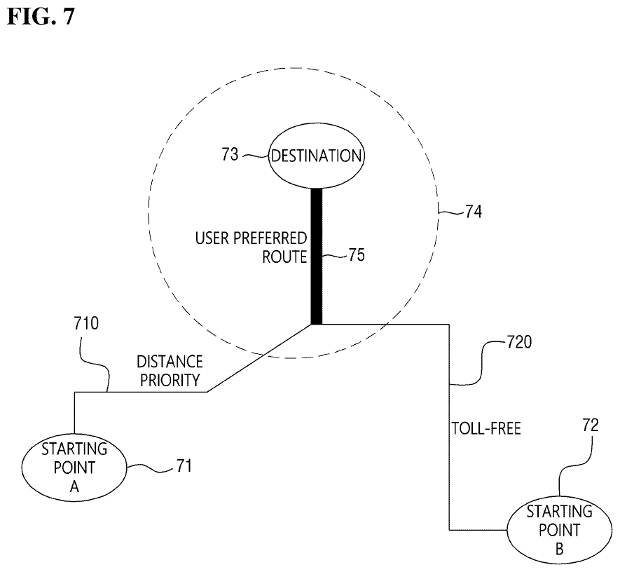

In an embodiment, referring to FIG. 7, the computing device 100 may provide a recommended route including a user preferred route 75 for a destination proximity area 74 corresponding to an area within a preset radius from a destination 73.

Here, the destination proximity area 74 may be set to an area within a radius input by a user of the computing device 100 from the destination 73 or may be set to an area within a radius stored as a default value in the computing device 100. For example, if the user of the computing device 100 inputs a setting value for the destination proximity area 74 as ‘3 km’, the destination proximity area 74 may be set to an area within a radius of 3 km from the destination 73.

The user preferred route 75 may be determined to be an actual driving route used three times or five times or more among actual driving routes that the user has actually used to reach the destination 73 within the destination proximity area 74.

If the destination input by the user is the same, but the starting point is different, a route generated using a general search option may be reflected from the starting point to an area outside the destination proximity area 74, and a recommended route reflecting the user preferred route 75 may be generated for the destination proximity area 74.

For example, when generating a recommended route from a starting point A (71) to the destination 73, the computing device 100 may apply a shortest distance route 710 using a ‘distance priority’ option from the starting point A (71) to the area outside the destination proximity area 74 and may apply the user preferred route 75 to the destination proximity area 74.

In addition, when generating a recommended route from a starting point B (72) to the destination 73, the computing device 100 may apply a toll-free route 720 using a ‘toll-free’ option from the starting point B (72) to the area outside the destination proximity area 74 and may apply the user preferred route 75 to the destination proximity area 74.

According to the above embodiment, a user may be provided with a recommended route that allows the user to drive using a user preferred route that the user has frequently traveled in an area around a destination regardless of the location of a starting point.

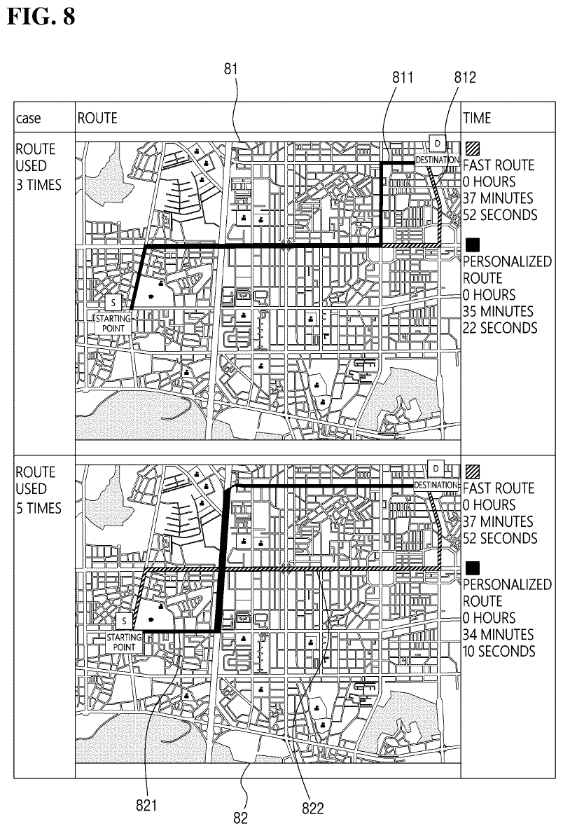

In an embodiment, referring to FIG. 8, the computing device 100 may generate a recommended route in a different manner according to the number of times that a user preferred route selected from actual driving routes of a user to reach a destination has been used and according to whether a starting point is included in the user preferred route.

For example, in a first navigation screen 81, the computing device 100 may generate a ‘personalized route’ (a user preferred route) 811 that has been used three times or more. If both a starting point and a destination are included in the ‘personalized route’ 811, a recommended route from the starting point to the destination may be generated using only the ‘personalized route’ 811. In this case, a ‘fast route’ 812 generated using an existing search option is not included in the recommended route, but may be displayed together with the ‘personalized route’ 811 so that they can be compared with each other.

On the other hand, in a second navigation screen 82, the computing device 100 may generate a ‘personalized route’ (a user preferred route) 821 that has been used five times or more. If the starting point is not included in the ‘personalized route’ 821, when a recommended route from the starting point to the destination is generated, a ‘fast route’ 822 generated using an existing search option may be reflected from the starting point to the vicinity of the destination, and the ‘personalized route’ 821 may be reflected from the vicinity of the destination to the destination.

In an embodiment, when providing a recommended route, the computing device 100 may provide a recommended route using a user preferred route at a starting point. Then, in response to entering within a preset distance from a destination, the computing device 100 may provide a route with a faster expected arrival time among a plurality of search results for the destination and the recommended route.

Accordingly, when providing a preferred route using actual driving routes used by a user, the computing device 100 may guide not just a user preferred route from the starting point to the destination. When entering the vicinity of the destination, the computing device 100 may also change the route to a faster route depending on traffic conditions around the destination and guide the faster route.

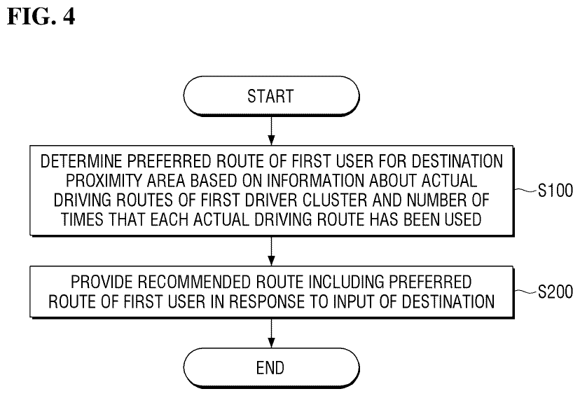

FIG. 4 is a flowchart illustrating a route search method using a user preferred route according to an embodiment of the present disclosure.

The route search method using the user preferred route may be executed by the user terminal 10 or the server 20 illustrated in FIG. 1. The user terminal 10 or the server 20 executing the route search method according may be the computing device 100 illustrated in FIG. 11. The user terminal 10 may be, for example, a smartphone, a navigation-only device, a tablet, etc. The server 20 may be a server device that provides a navigation service for route search.

It should be noted that a subject performing some operations included in the route search method according to the embodiment of the present disclosure may be omitted, and in such a case, the subject is the computing device 100.

According to the embodiment of the present disclosure described below, even when a new destination that a user has never actually driven to is input, a user preferred route can be generated using actual driving routes of drivers with similar driving tendencies to the user around the destination.

In an operation S100, the computing device 100 determines a preferred route of a first user for a destination proximity area based on information about actual driving routes used by a first driver cluster to reach a destination and the number of times that each actual driving route has been used. The destination proximity area refers to an area within a preset radius from the destination. For example, the destination proximity area may be set to an area within a radius input by a user of the computing device 100 or may be set to an area within a radius stored as a default value in the computing device 100. Here, the first user is a user corresponding to the first driver cluster.

In an embodiment, the computing device 100 may perform clustering using data about actual driving routes used by a plurality of drivers to reach the destination, thereby generating a plurality of driver clusters with different driving tendencies.

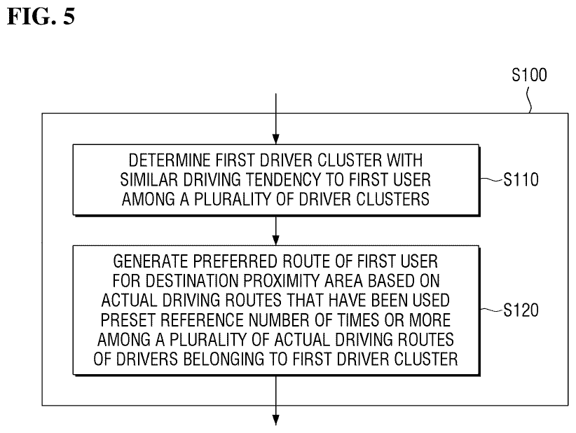

Referring to FIG. 5, operation S100 may include detailed operations S110 and S120.

In the operation S110, if the destination is not included in a plurality of actual driving routes of the first user, the computing device 100 may determine the first driver cluster with a similar driving tendency to the first user among the driver clusters generated through clustering based on an analysis of the actual driving routes of the first user.

In the operation S120, the computing device 100 may generate a preferred route of the first user for the destination proximity area based on actual driving routes of drivers which have been used a preset reference number of times or more among a plurality of actual driving routes used by drivers belonging to the first driver cluster to reach the destination.

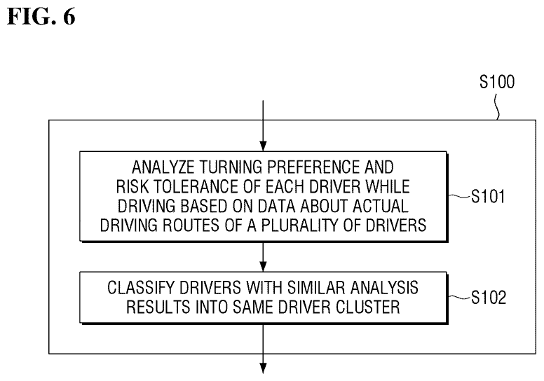

In an embodiment, referring to FIG. 6, when determining the preferred route of the first user for the destination proximity area, the computing device 100 may, in an operation S101, analyze turning preference and risk tolerance of each driver while driving based on the data about the actual driving routes of the drivers in order to generate a plurality of driver clusters with different driving tendencies. Accordingly, in an operation S102, the computing device 100 may generate a plurality of driver clusters with different driving tendencies by classifying drivers with similar analysis results into the same driver cluster.

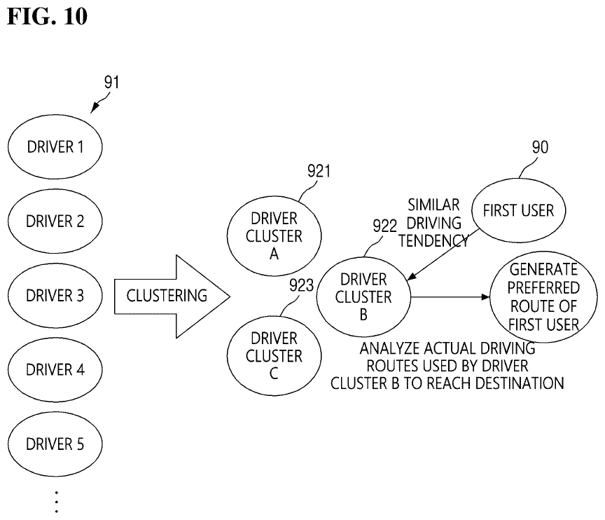

For example, referring to FIG. 10, if a destination is not included in actual driving routes used by a first user 90, the computing device 100 may perform clustering using information about actual driving routes of a plurality of drivers 91 who have a history of actually driving to the destination, thereby generating a plurality of driver clusters 921, 922 and 923 with different driving tendencies.

For example, the computing device 100 may analyze the actual driving routes of the drivers 91 and group drivers with similar driving tendencies into the same cluster based on whether each driver has a tendency to easily perform U-turns or lane changes while driving, whether each driver has a tendency to flexibly change routes when an accident section occurs on the road, or whether each driver has a tendency to change driving routes without difficulty when a route guided by a navigation system suddenly changes while driving.

In an example, the computing device 100 may analyze the actual driving routes of the first user 90 and determine ‘driver cluster B’ 922 with a similar driving tendency to the first user 90 among the driver clusters 921, 922 and 923 generated through clustering.

Accordingly, the computing device 100 may generate a preferred route of the first user 90 for a destination proximity area based on an actual driving route that has been used a preset reference number of times or more among a plurality of actual driving routes used by drivers belonging to the ‘driver cluster B’ 922 to reach the destination.

Referring again to FIG. 4, in an operation S200, the computing device 100 provides a recommended route including the preferred route of the first user in response to the input of the destination.

As described above, according to the method according to the embodiment of the present disclosure, in a search for a route to reach a new destination that a user has never actually driven to, a customized route can be provided to the user by using actual driving routes used around the destination by drivers with similar driving tendencies to the user.

As an additional embodiment, the computing device 100 may provide a user preferred route for a destination proximity area even when an input destination is not included in a user's actual driving route and when there is no information about a driver cluster with a similar driving tendency to the user.

For example, the computing device 100 may calculate a driving ratio of each road area between a starting point and a destination using data about actual driving routes of a plurality of drivers and may perform clustering for the road areas based on the driving ratio of each road area.

In an embodiment, if the input destination is not included in a user's actual driving route and if there is no information about a driver group with a similar driving tendency to the user, the computing device 100 may determine a first cluster corresponding to the starting point of the user and a second cluster corresponding to the destination among a plurality of clusters generated according to the driving ratio of each road area classified through clustering.

Accordingly, the computing device 100 may generate and provide a user preferred route for a destination proximity area based on a driving ratio of each cluster existing between the first cluster and the second cluster.

According to the various embodiments of the present disclosure described above, in a search for a route to reach a destination, a customized route for a user in a destination proximity area can be recommended based on routes that the user has actually traveled. In addition, search results may be provided so that routes found based on time, distance, etc. and a route preferred by the user can be compared. In addition, a customized route for the user can be recommended according to time based on the routes that the user has actually traveled.

In addition, in a search for a route to reach a new destination that the user has never actually driven to, a customized route can be provided to the user by using actual driving routes used around the destination by drivers with similar driving tendencies to the user.

FIG. 11 is a hardware configuration diagram of an exemplary computing device 100.

Referring to FIG. 11, a computing device 100 may include one or more processors 101, a bus 107, a network interface 102, a memory 103 that loads a computer program 105 executed by the processors 101, and a storage 104 for storing the computer program 105.

The processor 101 controls overall operations of each component of computing device 100. The processor 101 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 101 may perform calculations on at least one application or program for executing a method/operation according to various embodiments of the present disclosure. The computing device 100 may have one or more processors.

The memory 103 stores various data, instructions and/or information. The memory 103 may load one or more programs 105 from the storage 104 to execute methods/operations according to various embodiments of the present disclosure. An example of the memory 103 may be a RAM, but is not limited thereto.

The bus 107 provides communication between components of computing device 100. The bus 107 may be implemented as various types of bus such as an address bus, a data bus and a control bus.

The network interface 102 supports wired and wireless internet communication of the computing device 100. The network interface 102 may support various communication methods other than internet communication. To this end, the network interface 102 may be configured to comprise a communication module well known in the art of the present disclosure.

The storage 104 can non-temporarily store one or more computer programs 105. The storage 104 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 105 may include one or more instructions, on which the methods/operations according to various embodiments of the present disclosure are implemented. When the computer program 105 is loaded on the memory 103, the processor 101 may perform the methods/operations in accordance with various embodiments of the present disclosure by executing the one or more instructions.

In an embodiment, a computer program 105 may include instructions for performing an operation of determining a user preferred route for a destination proximity area based on information about a plurality of actual driving routes used by a user to reach a destination and the number of times that each actual driving route has been used and an operation of providing a recommended route including the user preferred route in response to the input of the destination, wherein the destination proximity area is an area within a preset radius from the destination.

In an embodiment, the computer program 105 may include instructions for performing an operation of determining a preferred route of a first user for a destination proximity area based on information about actual driving routes used by a first driver cluster to reach a destination and the number of times that each actual driving route has been used and an operation of providing a recommended route including the preferred route of the first user in response to the input of the destination, wherein the destination proximity area is an area within a preset radius from the destination, and the first user is a user corresponding to the first driver cluster.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should be understood that desired results can be obtained not only when the operations are performed in the specific order or sequential order or when all of the operations are performed. In certain situations, multitasking and parallel processing may be advantageous. According to the above-described embodiments, it should be understood that the separation of various configurations is not necessarily required. It should also be understood that the described program components and systems may generally be integrated together into a single software product or be packaged into multiple software products.

It is noted that those having ordinary skill in the art should appreciate that many variations and modifications can be made to the described embodiments without substantially departing from the principles of the present disclosure. Therefore, the described embodiments are used in a generic and descriptive sense only and not for purposes of limitation.

What is claimed is:

1. A route search method, comprising:
determining, by a computing device, a user preferred route for a destination proximity area based on information about a plurality of actual driving routes used by a user to reach a destination and a number of times that each actual driving route among the plurality of actual driving routes has been used; and
providing, by the computing device, a recommended route comprising the user preferred route in response to an input of the destination,
wherein the destination proximity area is an area within a preset radius from the destination.

2. The route search method of claim 1, wherein determining the user preferred route includes obtaining data about the plurality of actual driving routes used by the user collected during a preset period of time before the input of the destination and data about the number of times that each actual driving route has been used.

3. The route search method of claim 1, wherein determining the user preferred route includes generating, as the user preferred route, an actual driving route, among the plurality of actual driving routs, that has been used at least a preset reference number of times.

4. The route search method of claim 1, wherein determining the user preferred route includes:
obtaining information about a number of search requests made by the user for each actual driving route among the plurality of actual driving routes used by the user; and
generating, as the user preferred route, an actual driving route, among the plurality of actual driving routes used by the user, for which at least a preset reference number of search requests have been made.

5. The route search method of claim 1, wherein determining the user preferred route includes:
obtaining information about a driving ratio and required time of each of a plurality of roads traveled to reach the destination; and
generating, as the user preferred route, an actual driving route, among the plurality of actual driving routes used by the user, that requires a minimum time to reach the destination by using the driving ratio and required time of each of the roads.

6. The route search method of claim 1, wherein determining the user preferred route includes:
dividing data about the plurality of actual driving routes used by the user into weekday/weekend data and peak/off-peak data according to driving time; and
generating the user preferred route for each driving time by using the data divided according to the driving time.

7. The route search method of claim 1, wherein providing the recommended route comprising the user preferred route in response to the input of the destination includes:
providing the recommended route at a starting point; and
providing a route with a faster expected arrival time among the recommended route and a plurality of route search results for the destination in response to entering within a preset distance from the destination.

8. A route search method, comprising:
determining, by a computing device, a preferred route of a first user for a destination proximity area based on information about actual driving routes used by a first driver cluster to reach a destination and a number of times that each actual driving route, among the actual driving routes used by the first driver cluster, has been used; and
providing, by the computing device, a recommended route comprising the preferred route of the first user in response to an input of the destination,
wherein the destination proximity area is an area within a preset radius from the destination, and wherein the first user is a user corresponding to the first driver cluster.

9. The route search method of claim 8, wherein determining the preferred route of the first user for the destination proximity area includes generating a plurality of driver clusters with different driving tendencies by performing clustering using data about actual driving routes used by a plurality of drivers to reach the destination.

10. The route search method of claim 9, wherein determining the preferred route of the first user for the destination proximity area includes:
when the destination is not included in a plurality of actual driving routes used by the first user, determining the first driver cluster with a similar driving tendency to the first user among the driver clusters based on an analysis of the plurality of actual driving routes used by the first user; and
generating the preferred route of the first user for the destination proximity area based on actual driving routes of drivers that have been used at least a preset reference number of times among a plurality of actual driving routes used by drivers belonging to the first driver cluster to reach the destination.

11. The route search method of claim 9, wherein generating the driver clusters with the different driving tendencies includes:
analyzing turning preference and risk tolerance of each driver while driving based on the data about the actual driving routes used by the plurality of drivers; and
classifying drivers with similar analysis results into a same driver cluster.

12. A computing device comprising:
one or more processors;
a communication interface configured to communicate with an external device; and
a memory configured to store a computer program to be executed by the on one or more processors,
wherein the computer program comprises instructions for performing operations, including:
determining a user preferred route for a destination proximity area based on information about a plurality of actual driving routes used by a user to reach a destination and a number of times that each actual driving route, among the plurality of actual driving routes used by the user, has been used; and
providing a recommended route comprising the user preferred route in response to an input of the destination,
wherein the destination proximity area is an area within a preset radius from the destination.

13. The computing device of claim 12, wherein determining the user preferred route includes obtaining data about the plurality of actual driving routes of the user collected during a preset period of time before the input of the destination and data about a number of times that each actual driving route, among the plurality of actual driving routes, has been used.

14. The computing device of claim 12, wherein determining the user preferred route includes generating, as the user preferred route, an actual driving route, among the plurality of actual driving routes used by the user, that has been used at least a preset reference number of times.

15. The computing device of claim 12, wherein determining the user preferred route includes:
obtaining information about the number of search requests made by the user for each of the actual driving routes; and
generating, as the user preferred route, an actual driving route for which a preset reference number of search requests or more have been made among the actual driving routes of the user.

16. The computing device of claim 12, wherein determining the user preferred route includes:
obtaining information about a driving ratio and required time of each of a plurality of roads traveled to reach the destination; and
generating, as the user preferred route, an actual driving route that requires a minimum time to reach the destination among the actual driving routes of the user by using the driving ratio and required time of each of the roads.

17. The computing device of claim 12, wherein determining the user preferred route includes:
dividing data about the actual driving routes of the user into weekday/weekend data and peak/off-peak data according to driving time; and
generating the user preferred route for each time by using the data divided according to the driving time.

18. The computing device of claim 12, wherein providing the recommended route comprising the user preferred route in response to the input of the destination includes:
providing the recommended route at a starting point; and
providing a route with a faster expected arrival time among the recommended route and a plurality of route search results for the destination in response to entering within a preset distance from the destination.

19. The computing device of claim 12, wherein determining the user preferred route includes determining the user preferred route of the user for the destination proximity area based on information about actual driving routes used by a first driver cluster to reach the destination and the number of times that each actual driving route has been used, wherein the user is a user corresponding to the first driver cluster.

20. The computing device of claim 19, wherein determining the user preferred route of the user includes:
generating a plurality of driver clusters with different driving tendencies by performing clustering using data about actual driving routes used by a plurality of drivers to reach the destination;
when the destination is not included in the actual driving routes of the user, determining the first driver cluster with a similar driving tendency to the user among the driver clusters based on an analysis of the plurality of actual driving routes used by the user; and
generating the user preferred route of the user for the destination proximity area based on actual driving routes of drivers which have been used at least a preset reference number of times among a plurality of actual driving routes used by drivers belonging to the first driver cluster to reach the destination.
